(19) United States
(12) Patent Application Publication
(10) Pub. No.: US 2004/0213624 A1
(43) Pub. Date: Oct. 28, 2004

(54) Dispenser of a product, typically a cosmetic product, with magnetic support

(75) Inventor: Robert Petit, Savigny/Sur/Orge (FR)

Correspondence Address: YOUNG & THOMPSON, 745 SOUTH 23RD STREET 2ND FLOOR, ARLINGTON, VA, 22202

(73) Assignee: TECHPACK INTERNATIONAL, CHEVILLY-LARUE (FR)

(21) Appl. No.: 10/828,188

(22) Filed: Apr. 21, 2004

(30) Foreign Application Priority Data
Apr. 22, 2003 (FR) 03 04921

(51) Int. Cl. B43K 24/02; B65D 88/54; B43K 21/02

(52) U.S. Cl. 401/100; 401/55; 401/176

(57) ABSTRACT

The dispenser (1) comprises a body (2) with a tubular skirt (3) forming a cavity for the said product (6), a support (8) for the said product (6), a cap (5) and a means of manually making an axial displacement of the said support (8), and is characterised in that it comprises a slide (7), the said slide (7) and the said support (8) comprising parts attracted by radial magnetic forces such that the said axial displacement of the said slide (7) causes displacement of the said support (8).

Advantages: ease of assembly of the device and low manufacturing cost.

### DOMAIN OF THE INVENTION

The invention relates to the domain of stick product dispensers such as lip sticks, deodorant sticks, glue sticks, etc., or typically viscous products that flow under pressure, such as creams, pastes, etc.

### STATE OF THE ART

Many lipstick tube dispensers are already known, for example like those described in European applications No. 96500011, 98500016, 98500088, 99420027, 99420072, comprising a body and a cap.

The bodies of these lipstick tubes typically comprise three coaxial parts, including (working inwards from the outside) an outer body forming a skirt of the tube and in which two spiral grooves are typically formed on its inside surface, followed by a tubular element fixed to the bottom of the tube and on which two diametrically opposite axial orifices are formed, a support for the lip stick fitted with two diametrically opposite pins, the said pins passing through the said axial orifices and cooperating with the spiral grooves, such that relative rotation of the said body with respect to the said bottom causes an axial displacement of the said support and therefore of the said lip stick.

Deodorant dispensers for example like those described in French patent application No. 2 573 734 and European patent No. 0 462 925 are also known.

These dispensers typically comprise a body provided with a lateral skirt and a bottom, a piston forming a support for the deodorant stick cooperating with a central screw, which is rotated by an outer button forming all or part of the said bottom.

Problems that Arise

There are different sorts of problems with dispensers known in the state of the art.

Firstly, these dispensers form relatively complex parts assemblies in themselves, considering the number and precision required for their assembly, and are even more complex to assemble automatically, such that the production cost of these dispensers is relatively high.

Furthermore as shown in the case of lipstick tubes and deodorant dispensers, they make use of mechanisms for manual propulsion of the product that are distinct as a function of the product type, such that different machine investments are necessary depending on whether lipstick tubes or deodorant dispensers are being manufactured.

Finally, and particularly in the domain of packaging for cosmetic products, there is a continuous need to redesign the packaging, since the average life of packaging that can be extremely long in the case of perfume bottles, can also be very short for dispensers of products less prestigious than perfumes, such as those typically considered in this invention. The invention is intended to provide the solution to these problems.

### DESCRIPTION OF THE INVENTION

According to the invention, a product dispenser, typically a cosmetic product dispenser, comprises a body with a tubular skirt forming a cavity for the said product and provided with an opening at the top, a support for the said product being capable of moving in the axial direction in the said tubular skirt and thus forcing the said product to emerge through the said top opening so that it can be used and typically applied onto an application surface, a cap capable of closing off the said top opening by cooperation with the said tubular skirt, and a means of manually making an axial displacement of the said support with respect to the said tubular skirt, and it is characterized in that it comprises a slide outside the said tubular skirt, typically a ring, that can be moved manually along the said axial direction of the said tubular skirt, the said slide and the said support forming or comprising parts, one fixed on the said slide, the other fixed on the said support or forming the said support, parts attracted by radial magnetic forces such that the said axial displacement of the said slide causes displacement of the said support and thus the said product carried by the said support can emerge through the said top opening at will.

The characteristic means of this invention solve all the problems that arise.

The dispenser according to the invention comprises a propulsion system based on radial magnetic forces between a product support and an outer slide capable of sliding on the tubular skirt, an extremely simple system compared with systems required in lipstick tubes and in deodorant dispensers.

Furthermore, as will become clear in the remainder of the description and in the figures, this propulsion system is suitable for products of different natures such as lipstick, deodorants, or various products in the form of creams, pastes and more generally any fluid product with a certain viscosity at rest, in other words that does not flow in the absence of mechanical pressure applied to the product, and the invention does not relate to liquid products that can flow by themselves without any external pressure, such as products typically packaged in bottles closed by a cap.

Finally, apart from the fact that they form dispensers entirely different from dispensers according to the state of the art, dispensers according to the invention are also used differently, such that they form objects that persons using them cannot confuse them with objects according to the state of the art.

### DESCRIPTION OF FIGURES

All figures are axial sections and are related to the invention, except for FIG. 5b that is a partial section in a horizontal plane, and FIG. 6b that is a section in a horizontal plane.

FIGS. 1a to 1f, 2 and 3a to 3c relate to the same dispenser embodiment (1,1′).

FIG. 1a shows the dispenser (1) closed.

FIG. 1b shows the body (2) of the dispenser (1) formed from a single piece part made with a tubular skirt (3) and a bottom (4,4′).

FIG. 1c shows the cap (5) of the dispenser (1).

FIG. 1d shows the support (8) of the product (6,6′) that comprises a permanent magnet or a paramagnetic material (80).

FIG. 1e shows the slide (7,7′) that comprises a permanent magnet or a paramagnetic material (70), at least one of the two parts (7,7′) and (8) comprising a permanent magnet.

FIG. 1f shows a packaged product (6), the said product being a lip stick (6′).

FIG. 2 shows the dispenser (1) in FIG. 1a when open, the cap (5) having been separated from the body (2) and the slide (7,7′) have been moved upwards in order to force the said lip stick (6′) to emerge.

FIGS. 3a to 3c show enlarged views of the different means (84) of attaching the said product (6) to its support (8).

In FIG. 3a, the attachment means (84) comprises a dish (840) retaining the bottom of the lip stick (6′), the said dish typically being fixed to the support (8) by an adhesive layer or a glue dab (841) or possibly by click fitting, the lip stick (6′) and the attachment means (84) forming a removable assembly (9′) that can form a refill for the said dispenser.

In FIG. 3b, the support (8) comprises a recess (842) capable of retaining the bottom of the lip stick (6′).

In FIG. 3c, the support (8) forms an axial projection or a tip (843) capable of holding the bottom of the lip stick (6′).

FIG. 4a shows another dispenser (1, 1″) in which the said support (8) forms a piston (8′), in which the said product (6) is a cream type product (6″) in which the said bottom (4) forms a part (4″) distinct from the said tubular skirt (3) forming an attachment ring (41) acting as a stop for the said slide (7, 7′) and the said piston (8′), and in which the said skirt (3) comprises an arch (34) in its upper part (30) comprising a plurality of orifices (340).

FIG. 4b relates to another dispenser (1, 1″) in which the said support (8) forms a piston (8′), the said piston comprising a lower orifice closed off by a cap (83) to enable filling through the bottom, in which as shown in FIG. 2, the said bottom (4) forms a part (4″) distinct from the said tubular skirt (3) forming an attachment ring (41) acting as a stop for the said slide (7) and the said piston (8′), in which the said cap (5) forms a rounded part and comprises an inner lip seal (52) for the said product (6) that in this case is typically a deodorant stick (6′″).

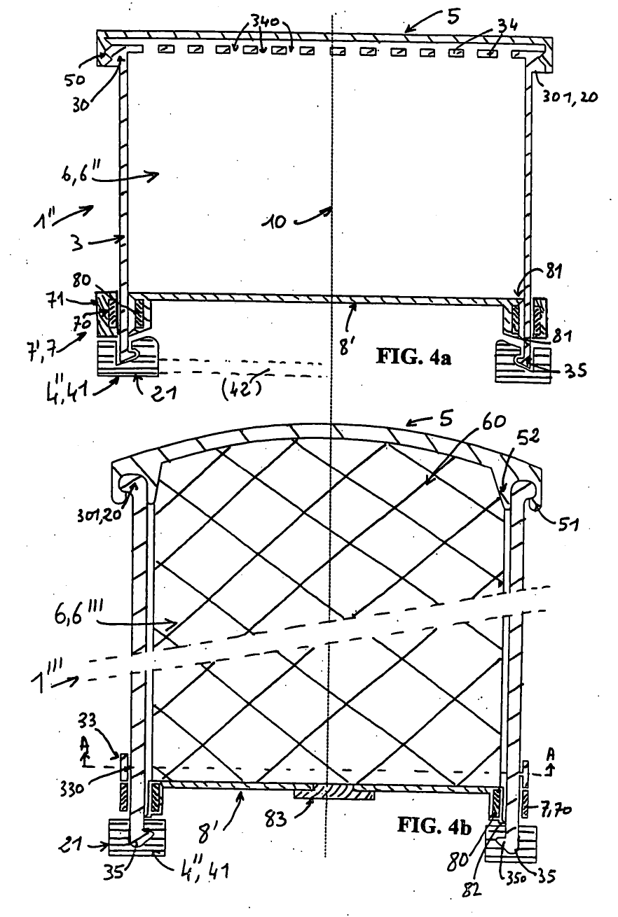

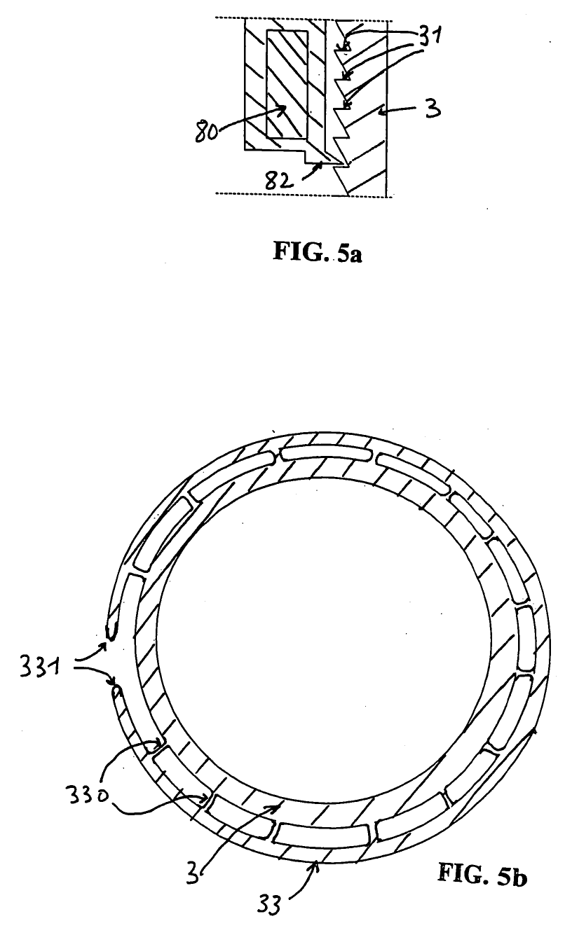

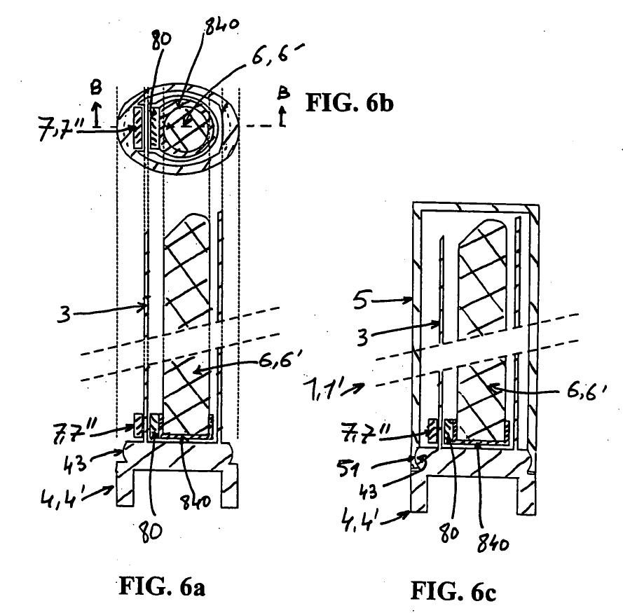

As shown in FIG. 5a, which is a partial enlarged view of the cooperation between a flexible edge (82) of the piston (8′) and several stop notches (31) formed on the inner surface of the skirt (3) in FIG. 4b, such that any forward displacement of the said piston is irreversible and the emerging part (60) of the product (6′″) can resist an arbitrary axial pressure during application of the deodorant (6′″) on the skin, without the risk of the deodorant stick moving towards the inside of the said body as soon as the axial pressure exceeds the resultant force due to the magnetic attraction between the said slide (7, 7′) and the said support (8).

As shown in FIG. 5b that is a partial section along plane A-A in FIG. 4b, the dispenser (1) comprises an axial blocking means (32) of the slide (7, 7′) before the first opening of the dispenser, so as to prevent any accidental displacement of the slide (7) and the piston (8′). This blocking means (32) comprises a tab (33) fixed by a plurality of bridges (330) to the said tubular skirt (3), the tab being placed so as to block the said slide in contact with the lower stop (21), the tab (33) being opened with two ends (331) so that it can be torn off manually the first time that the dispenser is opened.

FIGS. 6a to 6c relate to a dispenser embodiment (1, 1′) in which the said slide (7) is a non-annular lateral slide (7″).

FIG. 6a shows and axial section in the vertical plane B-B in FIG. 6b, showing the dispenser (1) open without its cap (5).

FIG. 6b shows a top view of the dispenser in FIG. 6a.

FIG. 6c shows a dispenser in FIG. 6a closed by its cap (5) by click fitting.

### DETAILED DESCRIPTION OF THE INVENTION

According to the invention, one of the said parts (70, 80) may comprise a permanent magnet, and the other part (80, 70) comprising a permanent magnet or a paramagnetic or ferromagnetic material with a typically positive magnetic susceptibility greater than 1, so as to form the said radial magnetic forces.

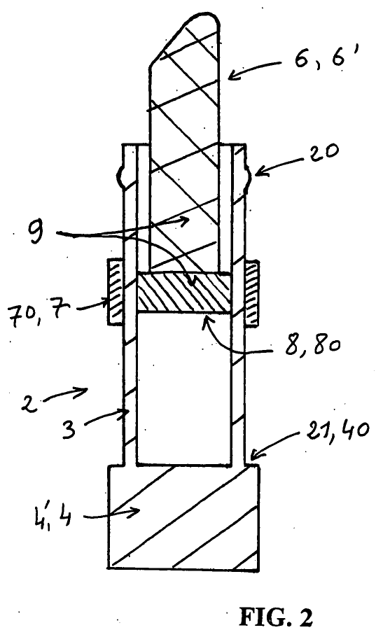

Typically, and as shown in the example in FIG. 2, the said body (2) or the said tubular skirt (3) may comprise or form a so-called “upper” stop (20) and a so-called “lower” stop (21) so as to limit the said axial travel distance of the said slide (7, 7′, 7″), and to fix the said slide (7, 7′, 7″) to the said body (2). However, these stops must not prevent assembly of the slide (7, 7′, 7″). In general, one of these stops must enable the slide (7, 7′, 7″) to pass when pressure is applied to it; this is the case of the upper stop (20) for the dispenser in FIG. 2.

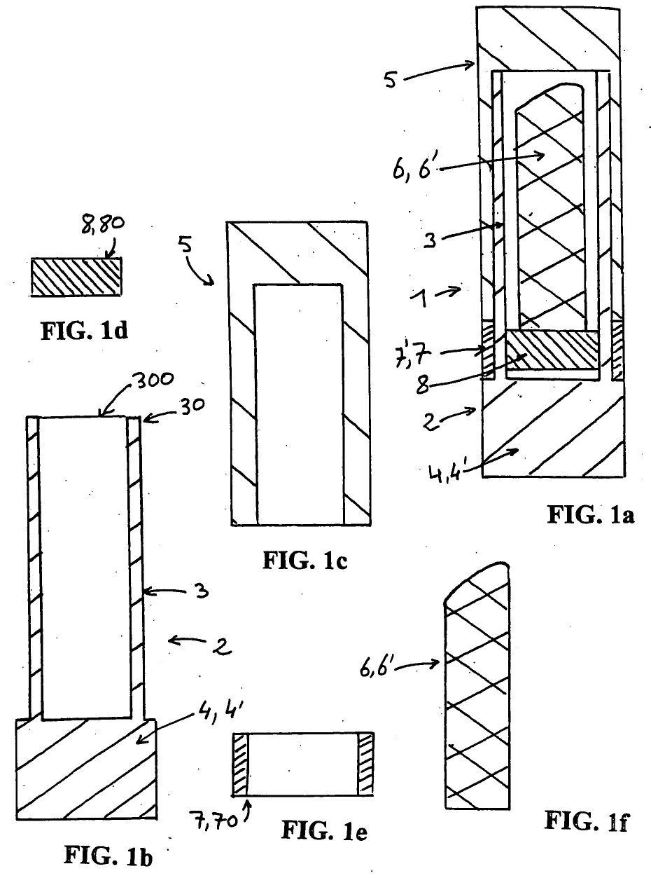

As shown particularly in FIGS. 1a, 1b and 2, the said body (2) may comprise a bottom (4), the said bottom (4) typically forming the said lower stop (21) due to a section or a diameter larger than the section or diameter of the said skirt forming a shoulder (40) capable of blocking the said slide (7, 7′, 7″). As shown on the same figures, the said bottom (4) may be a bottom (4′) forming a moulded single-piece part with the said skirt (3).

However, the said bottom (4) may be a bottom (4″) forming a part distinct from the said skirt (3), the said bottom (4″) and the said skirt (3) typically being assembled by click fitting or by gluing.

As shown in FIGS. 4a and 4b, the said bottom (4″) may comprise or form a ring (41) for attachment to the said skirt and possibly a central strip (42) as shown partially (in dashed lines) in FIG. 4a. When the bottom includes a central strip (42), it can then be used as a cover or means of closing off the bottom after filling through the bottom.

As shown in FIGS. 4a and 4b, the said support (8) may form a piston (8′) typically comprising a peripheral lip seal (81) such that the said piston (8′) cooperates with the said tubular skirt (3) in a typically leaktight manner.

The piston (8′) in FIG. 4a comprises two lip seals (81), the contact between the piston (8′) and the inner wall of the tubular skirt (3) being made by these two parallel peripheral lip seals.

However, the said part (80) may itself form the said piston, particularly when there is no need for leak tight sliding of the said part (80) in the said tubular skirt (3).

According to the invention, the said axial displacement may be reversible, therefore the said slide (7, 7′, 7″) is capable of coming into contact with the said lower stop (21) and possibly being held in contact with the said lower stop (21), particularly when the said top opening (300) is closed off by the said cap (5). In this case, the slide (7, 7′, 7″) may be in any position between the stops (20, 21) once the cap (5) has been removed.

According to one advantageous embodiment illustrated in FIG. 1a, the said cap (5), the said slide (7, 7′) and the said bottom (4, 4′, 4″) may have the same axial section, the said cap (5) being sufficiently high so that the said dispenser (1) has a uniform section over its entire height when it is closed, the said cap (5) closing off the said top opening (300).

In this case, the said slide, that can always return to the same place when the dispenser (1) is closed, may form a decorative element of the dispenser (1).

According to the invention, and as shown in FIGS. 4b and 5a, the said axial displacement may be irreversible, typically due to cooperation between a plurality of stop notches (31) formed on the inner surface of the said tubular skirt (3) and a flexible edge (82) of the said support (8), the said stop notches (31) being oriented so as to authorize only an upwards axial displacement corresponding to emergence of the said product (6) through the said orifice (300), particularly such that the said application of the said product can apply an axial force greater than the axial force generated by the said magnetic forces.

In this case, the position of the slide (7, 7′, 7″) along the tubular skirt (3) is a level indicator that accurately represents the height of the product remaining in the body (2) of the dispenser.

As shown in FIGS. 4a and 4b, the said upper part (30) of the said tubular skirt (3) may comprise or form an outer projection (301), the said outer projection (301) typically forming the said upper stop (20) and providing the said cooperation with the said cap, by screwing or by click fitting.

In FIG. 4a, this outer projection (301) is fitted with a thread, enabling screwing of the cap (5).

In FIG. 4b, this outer projection (301) enables click fitting of the cap (5).

As shown in FIGS. 4b and 5b, the said tubular skirt (3) may comprise a means of axial blocking (32) of the said slide (7, 7′, 7″) in contact with the said lower stop (21) before a first opening of the said dispenser (1), the said axial blocking means (32) forming a means of detecting the said first opening, and typically comprising a tab (33) connected to the said tubular skirt (3) by a plurality of bridges (330) that can be broken by pulling manually on one end (331) of the said tab (33) at the time of the said first opening.

According to the invention, the said dispenser may be of an arbitrary shape, the said tubular skirt (3) having a round, oval, rectangular or square axial section.

According to a variant illustrated in FIG. 4a, the said tubular skirt (3) may be obstructed near its upper part by an arch (34) in which a plurality of orifices (340) are formed, the said product (6) typically being a paste or cream product that can flow through the said orifices (340). In this variant, the dispenser can be filled through the bottom. In this case, it may be advantageous to fix the attachment ring (41) and the piston (8′) by bridges, so as to close off the bottom, after filling, by a single axial click fit to simultaneously assemble the piston (8′) and the ring (41).

But as shown in FIG. 4b, the said support (8, 8′) may comprise a filling orifice closed off by a cap (83) so that the said dispenser (1) can be filled with product (6) through its lower part.

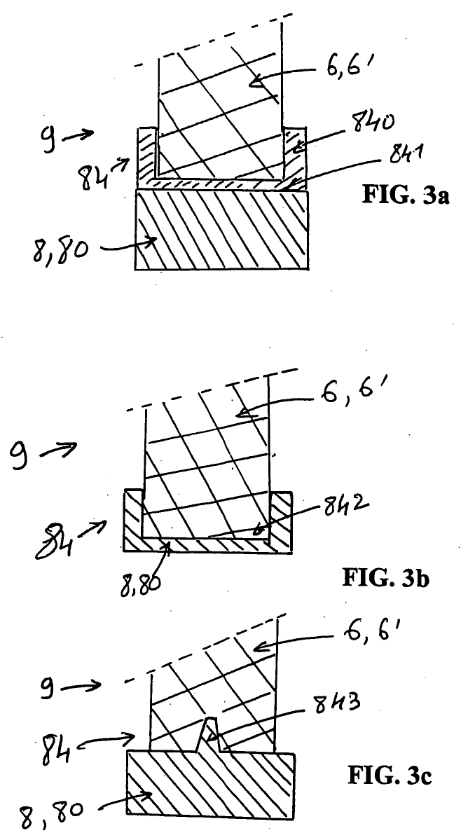

As shown in FIG. 3c, the said support (8) may comprise a means of fastening or anchoring (84) the said product (6), typically in the form of an axial projection (843) penetrating into the said product (6). This is the case particularly when the said product is a stick or lip stick, with sufficient consistency for an axial projection (843) to form a means of anchoring. Typically, the product is moulded onto the support and its axial projection (843).

As shown in FIGS. 1a to 5b, the said slide (7) can form a ring (7′), or a lateral slide (7″) as shown in FIGS. 6a to 6c, the said part (70) typically being encased in a plastic casing (71) as shown in FIG. 4a, so as to prevent direct contact between the said metallic part and the outer wall of the said tubular skirt (3), and thus preventing any risk of abrasion.

According to the invention, the said dispenser can have an H/D ratio typically between 0.8 and 10, where H is the largest axial dimension or height, and D is the larger radial dimension or diameter of the said closed dispenser.

According to one embodiment of the invention, the said H/D ratio may be greater than 3, the said product (6) typically being a lip stick (6′), the said dispenser (1) then forming a lipstick tube.

Typically, when the consistency of the said product is relatively solid, the said lip stick (6′) and the said support (8) can form a removable assembly (9), the said assembly forming a refill, so as to be able to change the said assembly either to change the lip stick grade, or when the said lip stick has been entirely consumed. For example, see FIG. 3b.

However, as shown in FIG. 3a, the said lip stick (6′) and the said anchor means (84) of the said support (8) can form a removable assembly (9′), the said assembly (9′) forming a refill, so as to be able to replace the said assembly either to change the lip stick grade, or when the said lip stick has been entirely consumed.

According to another embodiment of the invention, the said H/D ratio may be between 2 and 4, the said product (6) typically being a deodorant stick (6′″), the said dispenser (1) then forming a stick deodorant dispenser.

According to another embodiment of the invention, the said H/D ratio may be less than 4, the said product (6) typically being a viscous product such as a cream (6″), the said dispenser (1) then forming a cream dispenser.

Another purpose of the invention consists of using the dispenser (1) according to the invention to form a lipstick tube (1′) as shown in FIG. 2.

Another purpose of the invention consists of using the dispenser (1) according to the invention to form a dispenser (1″) of a viscous and fluid product, typically a cream, as shown in FIG. 4a.

Another purpose of the invention consists of using the dispenser (1) according to the invention to form a stick deodorant dispenser or applicator (1′″), as shown in FIG. 4b.

In this case, and as shown in FIG. 4b, the stick generally does not adhere to the inner wall of the tubular skirt (3) due to shrinkage caused by solidification of the liquid product added into the cavity, which correspondingly reduces friction forces to be overcome to achieve the said axial displacement.

Example Embodiments

The figures form example embodiments of dispensers (1) according to the invention. The dispenser (1, 1′) according to FIGS. 1a to 2 is made using a magnetized disk to form the said support (8) and the said part (80), the said disk having a diameter of 15 mm and a height of 3 mm, and an iron ring with an inside diameter of 18 mm, an outside diameter of 21 mm, therefore with a thickness of 1.5 mm, and a height of 5 mm corresponding to an air gap of 1.5 mm.

The other parts of the dispenser (1, 1′) were fabricated from plastic by moulding.

The resulting axial force is 3.3 N, which is greater than the friction resistance of the assembly (9) formed by the said support (8) and the said product (6, 6′), namely a lip stick.

In the assembly (9) in FIG. 2, the lip stick was fixed onto the magnetized disk (80) due to the roughness of the surface of the disk, or in some cases by a glue dab.

FIGS. 3a to 3c illustrate other variant embodiments to fix the lip stick to its support and form the said assembly (9).

A dispenser (1, 1″) according to FIG. 4a was also made, to distribute a viscous and fluid product such as a makeup cream or face care cream (6″).

A dispenser similar to that shown in FIG. 4a was also made, but with an arch (34) and an arch-shaped cap (5) as shown in FIG. 4b.

A dispenser similar to that in FIG. 4a was also made in which the attachment ring (4″, 41) cooperates with the piston (8′) and with the ring (7′), so as to form a manipulable assembly (4″+7′+8′) that can be fixed on the lower part (35) of the tubular skirt (2) by axial click fitting after the said product (6, 6″) has been loaded into the cavity formed by the said tubular skirt (3) closed by the said cap (5) and in the reverse position.

A dispenser (1, 1′″) according to FIGS. 4b to 5b was also made, to dispense a stick type product (6′″), typically a deodorant. The deodorant was introduced as a liquid through an orifice in the piston (8′), the dispenser (1′″) being in the inverted position, the said orifice then being closed off by the cap (83) or by an adhesive label.

In the case of the dispensers (1″) and (1′″) in FIGS. 4a and 4b, two coaxial rings (70) and (80) are used as parts, one (70) being a permanent magnet, and the other (80) being made of iron, both being 2 mm thick, with heights of 8 and 6 mm respectively, with an air gap equal to 2 mm, the inside diameter D for the outer ring (70) being 40 mm.

The result was an axial force of the order of about 14 N, which is quite sufficient to force the products (6″) and (6′″) in the axial direction.

The ring (80) was insert-moulded with the piston (8′) and similarly, the ring (70) of the dispenser (1″) in FIG. 4a was insert-moulded with the moulding encased in a plastic material.

In the case of dispensers (1″) and (1′″), the lower end (35) of the tubular skirt (3) comprises an inner radial projection (350) with an oriented profile chosen so that the said piston (8′) fitted with the said ring (80) can be force fitted—in the axial direction (10), and so that the attachment ring (41) can be click fitted.

In the case of the dispenser (1′″) in FIGS. 4b to 5b, the tubular skirt (3) was moulded with a tab or guarantee strip (33) connected by bridges (330) to the skirt (3). This method also forms a means of axially blocking the said slide (7), and a means of detecting the first opening.

The dispenser (1, 1′) according to FIGS. 6a to 6c was also manufactured, in this case the shape of the dispenser is oval, and the said slide (7) is a lateral slide (7″). In this case, the said support (8) comprises the said part (80) laterally fixed to a dish (840) into which the said lip stick (6,6′) is force fitted. The dispenser comprises an upper stop (20) for the said lateral slide (7″), this stop not being shown on the figures, the skirt (3) forming an axial guidance channel for the said lateral slide (7″) as shown in FIG. 6b.

Regardless of the example embodiment, it may be advantageous if the said slide cooperates with the outer surface of the said tubular skirt with a degree of friction corresponding to a friction force typically varying from 1 to 3 N, such that when the said dispenser (1) is open and in the vertical position, the product (6) being delivered for example as shown in FIG. 2, the weight of the assembly (9) does not pull the slide (7) downwards.

Depending on the said friction force, it may or may not be necessary to hold the slide manually in its axial position during application of the said product onto the skin or the face.

### ADVANTAGES OF THE INVENTION

The invention has major advantages.

It enables manufacture of dispensers with a limited number of parts, and also assembly of these parts with a simple axial assembly, which is economically very advantageous.

Furthermore, it has been found that a small spring effect occurs when the said product (6) is applied, which is not the case with dispensers according to prior art. This makes application of the said product more flexible and is a great benefit for the user. This spring effect is caused by magnetic coupling between the slide (7) assumed to be fixed during the said application, and the support (8) that is free to move in the axial direction.

Even when the axial displacement of the slide (7) is irreversible, as shown in FIG. 5b, the flexible edge (82) may be chosen so as to keep this spring effect.

Finally, the invention leads to a new means of operating and using the said dispenser, and a new presentation of these dispensers, such that dispensers according to the invention can very easily be identified, such that they have a high “discrimination” capacity compared with the dispensers according to the state of the art, and this is usually a very desirable property when packaging and marketing cosmetic and skin care products.

List of Marks

Dispenser 1

Dispenser forming a lipstick tube 1′

Dispenser for a viscous product or cream 1″

Stick deodorant dispenser 1′″

Axial direction 10

Body of 1 2

Upper stop of 7 20

Lower stop of 7 21

Tubular skirt of 2 3

Upper part 30

Top opening 300

Outer projection 301

Stop notches 31

Axial blocking means for 7 32

Tab 33

Connection bridges between -33 and 3 330

End 331

Arch 34

Orifices 340

Lower part 35

Inner projection 350

Bottom of 2 4

Bottom as single-piece part with 3 4′

Bottom as part separate from 3 4″

Shoulder 40

Attachment ring with 3 41

Central strip 42

Click fit part on 51 43

Cap of 1 5

Threaded part cooperating with 300 50

Click fit part on 300—hook 51

Inner lip seal 52

Product 6

Lip stick 6′

Viscous cream type product 6″

Deodorant stick 6′″

Emerging part 60

Slide 7

Ring 7′

Non-annular lateral slide 7″

Permanent magnet or paramagnetic material 70

Plastic casing 71

Support of 6 8

Piston 8′

Permanent magnet or paramagnetic material 80

Peripheral lip seal 81

Flexible edge 82

Cap 83

Attachment means 84

Dish 840

Adhesive layer 841

Recess 842

Axial projection 843

Removable “product (6)+support (8)” assembly=refill 9

Removable “product (6)+attachment means 84” assembly 9′

1. Dispenser (1) of a product (6), typically a cosmetic product dispenser, comprising a body (2) with a tubular skirt (3) forming a cavity for the said product (6) and provided with a top opening (300) in its upper part (30), a support (8) for the said product (6) capable of moving in the axial direction in the said tubular skirt (3) and thus forcing the said product (6) to emerge through the said top opening (300) so that it can be used and typically applied onto an application surface, a cap (5) capable of closing off the said top opening (300) by cooperation with the said tubular skirt (3), and a means of manually making an axial displacement of the said support (8) with respect to the said tubular skirt (3), characterized in that it comprises a slide (7) outside the said tubular skirt (3), forming a ring (7′) that can be moved manually along the said axial direction of the said tubular skirt (3), the said ring (7′) forming a part (70), the said support (8) forming or comprising another part (80), the said parts (70) and (80) being attracted by radial magnetic forces, such that the said axial displacement of the said slide (7) causes displacement of the said support (8) and thus the said product (6) carried by the said support (8) can emerge through the said top opening (300) at will.

2. Dispenser according to claim 1, in which one of the said parts (70, 80) comprises a permanent magnet, the other part (80, 70) comprises a permanent magnet, or a paramagnetic or ferromagnetic material with a typically positive magnetic susceptibility greater than 1, so as to form the said radial magnetic forces.

3. Dispenser according to claim 1, in which the said body (2) or the said tubular skirt (3) comprise or form a so-called “upper” stop (20) and a so-called “lower” stop (21) so as to limit the said axial travel distance of the said slide (7, 7′, 7″), and to fix the said slide (7, 7′, 7″) to the said body (2).

4. Dispenser according to claim 1, in which the said body (2) comprises a bottom (4), the said bottom (4) typically forming the said lower stop (21) due to a section or a diameter larger than the section or diameter of the said skirt forming a shoulder (40) capable of blocking the said slide (7, 7′, 7″).

5. Dispenser according to claim 4 in which the said bottom (4) is a bottom (4′) forming a moulded single-piece part with the said skirt (3).

6. Dispenser according to claim 4 in which the said bottom (4) is a bottom (4″) forming a part distinct from the said skirt (3), the said bottom (4″) and the said skirt (3) typically being assembled by click fitting or by gluing.

7. Dispenser according to claim 6 in which the said bottom (4″) comprises or forms a ring (41) for attachment to the said skirt and possibly a central strip (42).

8. Dispenser according to claim 1, in which the said support (8) forms a piston (8′) typically comprising a peripheral lip seal (81) such that the said piston (8′) cooperates with the said tubular skirt (3) in a typically leak tight manner.

9. Dispenser according to claim 1, in which the said axial displacement is reversible, and in which the said slide (7, 7′, 7″) is therefore capable of coming into contact with the said lower stop (21), and possibly being held in contact with the said lower stop (21), particularly when the said top opening (300) is closed off by the said cap (5).

10. Dispenser according to claim 9, in which the said cap (5), the said slide (7, 7′) and the said bottom (4, 4′, 4″) have the same axial section, and in which the said cap (5) is sufficiently high so that the said dispenser (1) has a uniform section over its entire height when it is closed, the said cap (5) closing off the said top opening (300).

11. Dispenser according to claim 1, in which the said axial displacement is irreversible, typically due to cooperation between a plurality of stop notches (31) formed on the inner surface of the said tubular skirt (3) and a flexible edge (82) of the said support (8), the said stop notches (31) being oriented so as to authorize only an upwards axial displacement corresponding to emergence of the said product (6) through the said orifice (300), particularly such that the said application of the said product can apply an axial force greater than the axial force generated by the said magnetic forces.

12. Dispenser according to claim 1, in which the said upper part (30) of the said tubular skirt (3) comprises or forms an outer projection (301), the said outer projection (301) typically forming the said upper stop (20) and providing the said cooperation with the said cap, by screwing or by click fitting.

13. Dispenser according to claim 12, in which the said tubular skirt (3) comprises a means of axial blocking (32) of the said slide (7, 7′, 7″) in contact with the said lower stop (21) before a first opening of the said dispenser (1), the said axial blocking means (32) forming a means of detecting the said first opening, and typically comprising a tab (33) connected to the said tubular skirt (3) by a plurality of bridges (330) that can be broken by pulling manually on one end (331) of the said tab (33) at the time of the said first opening.

14. Dispenser according to claim 1, in which the said tubular skirt (3) has a round, oval, rectangular or square axial section.

15. Dispenser according to claim 1, in which the said tubular skirt (3) is obstructed near its upper part by an arch (34) in which a plurality of orifices (340) are formed, the said product (6) typically being a paste or cream product that can flow through the said orifices (340).

16. Dispenser according to claim 1, in which the said support (8, 8′) comprises a filling orifice closed off by a cap (83) so that the said dispenser. (1) can be filled with product (6) through its lower part.

17. Dispenser according to claim 1, in which the said support (8) comprises a means (84) of fastening or anchoring the said product (6), typically in the form of an axial projection (843) penetrating into the said product (6).

18. Dispenser according to claim 1, in which the said slide (7) forms a ring (7′), or a lateral slide (7″), the said part (70) typically being encased in a plastic casing (71).

19. Dispenser according to claim 1, with an H/D ratio typically between 0.8 and 10, where H is the largest axial dimension or height, and D is the larger radial dimension or diameter of the said closed dispenser.

20. Dispenser according to claim 19, in which the said H/D ratio is greater than 3, the said product (6) typically being a lip stick (6′), the said dispenser (1) then forming a lipstick tube.

21. Dispenser according to claim 20 in which the said lip stick (6′) and the said support (8) form a removable assembly (9), the said assembly forming a refill so as to be able to change the said assembly either to change the lip stick grade, or when the said lip stick has been entirely consumed.

22. Dispenser according to claim 20 in which the said lip stick (6′) and the said anchor means (84) of the said support (8) form a removable assembly (9′), the said assembly (9′) forming a refill so as to be able to replace the said assembly either to change the lip stick grade, or when the said lip stick has been entirely consumed.

23. Dispenser according to claim 19 in which the said H/D ratio is between 2 and 4, the said product (6) typically being a deodorant stick (6′″), the said dispenser (1) then forming a stick deodorant dispenser.

24. Dispenser according to claim 19 in which the said H/D ratio is less than 4, the said product (6) typically being a viscous product such as a cream (6″), the said dispenser (1) then forming a cream dispenser.

25. (canceled)

26. (canceled)

27. (canceled)
